(19) United States
(12) Patent Application Publication
(10) Pub. No.: US 2026/0239164 A1
(43) Pub. Date: Aug. 13, 2026

(54) WIRELESS COMMUNICATION SYSTEM, WIRELESS COMMUNICATION METHOD, WIRELESS COMMUNICATION DEVICE AND WIRELESS COMMUNICATION PROGRAM

(71) Applicants: NTT, Inc., Tokyo (JP); NTT DOCOMO, INC., Tokyo (JP)

(72) Inventors: Hisayoshi KANO, Musashino-shi, Tokyo (JP); Munehiro MATSUI, Musashino-shi, Tokyo (JP); Junichi ABE, Musashino-shi, Tokyo (JP); Fumihiro YAMASHITA, Musashino-shi, Tokyo (JP); Yuki HOKAZONO, Tokyo (JP); Hinata KOHARA, Tokyo (JP); Kenji FUKASAWA, Tokyo (JP)

(73) Assignees: NTT, Inc., Tokyo (JP); NTT DOCOMO, INC., Tokyo (JP)

(21) Appl. No.: 19/156,426

(22) PCT Filed: Feb. 21, 2023
(86) PCT No.: PCT/JP2023/006206

§ 371 Date: Aug. 14, 2025

(51) Int. Cl. H04W 40/22; H04L 45/00; H04W 72/0453; H04W 84/06

(52) U.S. Cl. CPC H04W 40/22; H04L 45/20; H04W 72/0453; H04W 84/06

(57) ABSTRACT

The wireless communication system includes: a terminal station, a terrestrial base station, a plurality of node stations, a route control circuitry, and a management circuitry. The route control circuitry is configured to perform: calculating band usage rates of communication links formed among the plurality of node stations; setting a plurality of communication routes to be candidates; calculating cost values of the plurality of communication routes to be the candidates, based on the band usage rates and delay times; and comparing the cost values and selecting a communication route with the smallest cost value from among the plurality of communication routes to be the candidates. The management circuitry is configured to perform allocating bands to communication links included in the selected communication route. The terminal station and the terrestrial base station perform wireless communication using the bands allocated to the communication links included in the selected communication route.

### TECHNICAL FIELD

The present disclosure relates to a wireless communication system, a wireless communication method, a wireless communication device, and a wireless communication program.

### BACKGROUND ART

In recent years, mobile communication systems have developed, and it is possible to enjoy mobile services on most of the earth. One of requirements for the fifth-generation and subsequent mobile communication systems expected to be commercialized in the future is extreme coverage extension. The extreme coverage extension is to extend a service area to existing places where the construction cost of a base station is high or where construction of a base station is difficult, such as in the mountain, on the sea, or in the air.

In order to realize the above, attention has been attracted to a non-terrestrial network (NTN) using node stations such as satellites, unmanned aerial vehicles (UAV), high-altitude pseudo satellites (HAPS), or drones. In the NTN, the node stations form a network by mutually connecting communication links and connect to a mobile network on the earth via a base station on the earth. Traffic that occurs in a terminal station on the earth is transferred to a node station that is communicable with the base station on the earth, in the NTN.

### CITATION LIST

### Non Patent Literature

[NPL 1] “A Study on an Efficient Route Control Method for Two-Layered Satellite Networks” by Tada, Nishiyama, Yoshimura, and Kato, IEICE Technical Report, SAT2010-9

### SUMMARY OF INVENTION

### Technical Problem

A route control method for the NTN described above has been examined on the assumption of a regenerative relaying method in which demodulation processing is performed when a node station relays a signal. For example, PTL 1 discloses a technology in which a router operating according to a Layer 3 protocol of the OSI reference model, such as RIP or OSPF, decides a communication route. However, in the case of a non-regenerative relaying method in which, at the time of a node station relaying a signal, only frequency conversion and power amplification are performed, and demodulation processing is not performed, there is a problem that a conventional method cannot be applied.

In order to solve the above problem, a primary object of the present disclosure is to provide a wireless communication device capable of performing NTN route control even when a regenerative relaying method is not used.

### Solution to Problem

A first aspect of the present disclosure is preferably a wireless communication system for performing communication using a non-terrestrial network constructed by a non-regenerative relaying method, the wireless communication system comprising: a terminal station, a terrestrial base station, a plurality of node stations constituting the non-terrestrial network, a route control device, and a management device, wherein the route control device is configured to perform: a process for calculating band usage rates of communication links formed among the plurality of node stations; a process for setting a plurality of communication routes to be candidates; a cost value calculation process for calculating cost values of the plurality of communication routes to be the candidates, based on the band usage rates and delay times; and a process for comparing the cost values and selecting a communication route with the smallest cost value from among the plurality of communication routes to be the candidates, and the management device is configured to perform a process for allocating bands to communication links included in the selected communication route, and the terminal station and the terrestrial base station perform wireless communication using the bands allocated to the communication links included in the selected communication route.

A second aspect of the present disclosure is preferably a wireless communication method implemented by a wireless communication system, the wireless communication system performing communication using a non-terrestrial network constructed by a non-regenerative relaying method and configured with a plurality of node stations, and the wireless communication method comprising: calculating band usage rates of communication links formed among the plurality of node stations; setting a plurality of communication routes to be candidates; calculating cost values of the plurality of communication routes to be the candidates, based on the band usage rates and delay times; comparing the cost values and selecting a communication route with the smallest cost value from among the plurality of communication routes to be the candidates; allocating bands to communication links included in the selected communication route; and performing wireless communication using the bands allocated to the communication links included in the selected communication route.

A third aspect of the present disclosure is preferably a wireless communication device comprised in a wireless communication system, the wireless communication system performing communication using a non-terrestrial network constructed by a non-regenerative relaying method and configured with a plurality of node stations, and the wireless communication device comprising a route control device and a management device, wherein the route control device is configured to perform: a process for calculating band usage rates of communication links formed among the plurality of node stations; a process for setting a plurality of communication routes to be candidates; a process for calculating cost values of the plurality of communication routes to be the candidates, based on the band usage rates and delay times; and a process for comparing the cost values and selecting a communication route with the smallest cost value from among the plurality of communication routes to be the candidates, and the management device is configured to perform a process for allocating bands to communication links included in the selected communication route.

A fourth aspect of the present disclosure is preferably a wireless communication program implemented by a wireless communication device comprised in a wireless communication system, the wireless communication system performing communication using a non-terrestrial network constructed by a non-regenerative relaying method and configured with a plurality of node stations, and the wireless communication program comprising a program for causing a computer to perform: a process for calculating band usage rates of communication links formed among the plurality of node stations; a process for setting a plurality of communication routes to be candidates; a process for calculating cost values of the plurality of communication routes to be the candidates, based on the band usage rates and delay times; a process for comparing the cost values and selecting a communication route with the smallest cost value from among the plurality of communication routes to be the candidates, and a process for allocating bands to communication links included in the selected communication route.

### Advantageous Effects of Invention

According to first to fourth aspects of the present disclosure, it is possible to perform NTN route control even when a regenerative relaying method is not used.

### BRIEF DESCRIPTION OF DRAWINGS

FIG. 1 is a diagram showing a wireless communication system according to a first embodiment of the present disclosure.

FIG. 2 is a diagram showing a communication route calculation method according to the first embodiment of the present disclosure.

FIG. 3 is a diagram showing a configuration of a modification of the wireless communication system according to the first embodiment of the present disclosure.

FIG. 4 is a diagram showing a configuration of a wireless communication device mounted on a node station, according to the first embodiment of the present disclosure.

FIG. 5 is a diagram showing a configuration of the network controller according to the first embodiment of the present disclosure.

FIG. 6 is a diagram showing a hardware configuration of the wireless communication device according to the first embodiment of the present disclosure.

FIG. 7 is a flowchart showing a route calculation method according to the first embodiment of the present disclosure.

FIG. 8 is a diagram showing a wireless communication system according to a second embodiment of the present disclosure.

FIG. 9 is a flowchart showing a route calculation method according to the second embodiment of the present disclosure.

FIG. 10 is a diagram showing a wireless communication system according to a third embodiment of the present disclosure.

FIG. 11 is a flowchart showing a route calculation method according to the third embodiment of the present disclosure.

FIG. 12 is a diagram showing a wireless communication system according to a fourth embodiment of the present disclosure.

### DESCRIPTION OF EMBODIMENTS

### First Embodiment

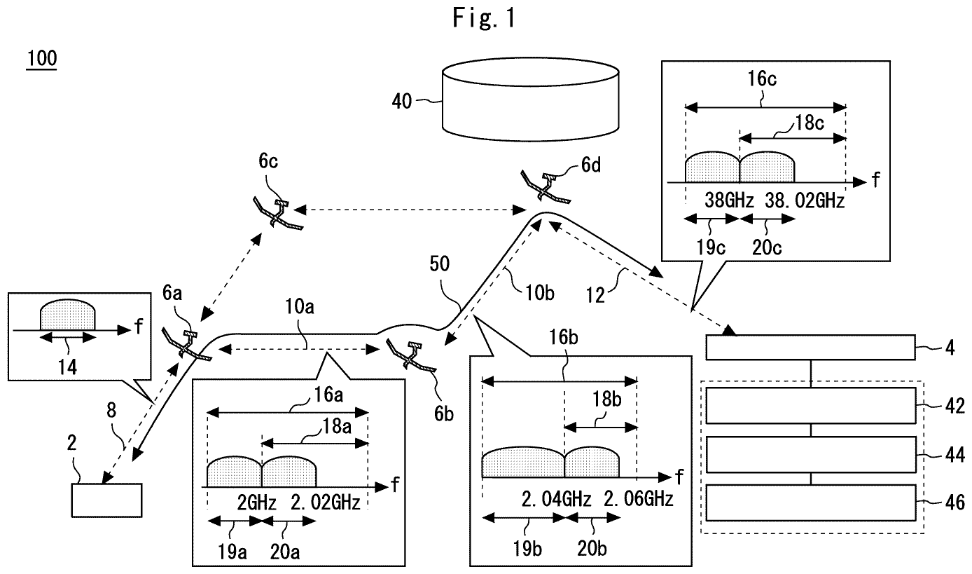

FIG. 1 is a diagram showing a wireless communication system according to a first embodiment of the present disclosure. A wireless communication system 100 includes a terminal station 2. The terminal station 2 is, for example, a terminal station installed on the earth. Traffic that occurs in the terminal station 2 is transmitted to a terrestrial base station 4. At this time, the traffic is relayed by node stations 6a, 6b, and 6d without being relayed by a node station 6c. That is, the NTN route control in this case is equivalent to selecting appropriate node stations to decide a communication route 50 which is the optimal route from the terminal station 2 to the terrestrial base station 4.

An example of a route optimized by NTN route control will be described using FIG. 1. First, the traffic that occurs in the terminal station 2 is transmitted to the node station 6a via a service link 8. At this time, on the service link 8, a band 14 is allocated as a band required for the communication route 50. The required band is, for example, 20 MHz. Furthermore, the required band is allocated on a per-component carrier basis.

Note that, in the non-regenerative relaying method, when a node station relays a signal, only frequency conversion and power amplification are performed, and demodulation processing is not performed. Therefore, the node station 6a cannot perform traffic identification by IP address. Therefore, the node station 6a identifies traffic based on band difference.

Next, the traffic is transmitted to the node station 6b via a communication link 10a. The communication link 10a has a band 19a that is already used, in a full bandwidth 16a that can be used. Therefore, in the communication link 10a, a band 20a is allocated from a free space 18a as a band required for the communication route 50. The required band is, for example, 20 MHz.

Here, the node station 6b holds band allocation information. Then, at the time of relaying a signal, the node station 6b converts frequency according to the band allocation information. As the band allocation information held by the node station 6b, Table 1 can be exemplified.

TABLE 1

| Reception source link/band | Transfer destination link/band |
|---|---|
| Communication link 10a/2.00- | Communication link 10b/2.04- |
| 2.02 GHz | 2.05 GHz |
| Communication link 10b/2.04- | Communication link 10a/2.04- |
| 2.06 GHz | 2.06 GHz |

Next, the traffic is transmitted to the node station 6d via a communication link 10b. The communication link 10b has a band 19b that is already used, in a full bandwidth 16b that can be used. Therefore, in the communication link 10b, a band 20b is allocated from a free space 18b as a band required for the communication route 50. The required band is, for example, 20 MHz.

Next, the traffic is transmitted to the terrestrial base station 4 via a feeder link 12. The feeder link 12 has a band 19c that is already used, in a full bandwidth 16c that can be used. Therefore, in the feeder link 12, a band 20c is allocated from a free space 18c as a band required for the communication route 50. The required band is, for example, 20 MHz.

The terrestrial base station 4 transmits the received traffic to an RU 42. The RU 42 is a radio unit. The RU 42 transmits the traffic to a DU 44. The DU 44 is a distributed unit. The DU 44 transmits the traffic to a CU 46. The CU 46 is a central unit. Note that the RU 42, the DU 44, and the CU 46 are included in a cellular communication base station (gNB).

Furthermore, the wireless communication system 100 includes a network controller 40. The network controller calculates an optimal communication route in the wireless communication system 100. Specifically, the network controller 40 manages the band usage status of each communication link and allocates a required band to an available band of the communication link. For example, in the case of an NTN configuration in which the RU is arranged on the terrestrial base station 4 side, and the terminal station performs cellular communication with a node station, bands are allocated on a per-cellular communication component carrier basis. Each node station holds band allocation information and, at the time of relaying a signal, converts frequency according to the information.

Note that calculation of a communication route may be performed under centralized control that is performed by the network controller 40 as described above or may be performed under distributed control in which each node station individually performs route calculation.

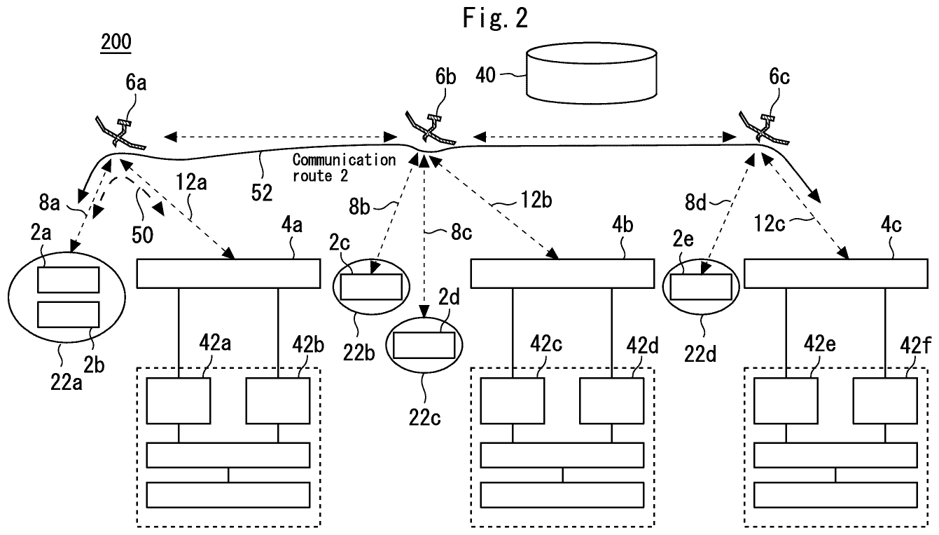

FIG. 2 is a diagram showing a communication route calculation method according to the first embodiment of the present disclosure. In cellular communication used in the present embodiment, one communication area, that is, a communication area corresponding to one cell is formed for one RU. In the case of the NTN configuration in which the RU is arranged in the terrestrial base station, it becomes necessary to, accompanying change of a communication route, switch the RU to cover a cell.

Therefore, each terrestrial base station is caused to manage the number of unused RUs. When there are a plurality of communication route candidates, the network controller 40 confirms the number of unused RUs of terrestrial base stations to be candidates. Then, if there is such a terrestrial base station that the number of unused RUs is below the required number of RUs, the feeder link with the terrestrial base station is excluded from cost value calculation targets. Then, a communication route cost value C is calculated for each of communication links that are not excluded, using Formulae 1 and 2, and a communication route with the smallest cost value C is selected. Note that each reference value is any value.

$$C = {\sum }_{i = 1}^{n} {C}_{i} \qquad [ Formula 1 ]$$

$${C}_{i} = \frac{band utilization rate of communication link}{reference value of band utilization rate} + \frac{delay time of communication link}{reference value of delay time} \qquad [ Formula 2 ]$$

Note that n is the total number of communication links included in each communication route. Furthermore, the communication link cost value Ci is determined from the band usage rate and the delay time. The band usage rate is calculated using Formula 3.

$$band usage rate = \frac{bandwidth allocated to other communication routes}{full bandwidth of communication link} \qquad [ Formula 3 ]$$

Note that, when an available band is below a required bandwidth, it is acceptable that either (1) the link is not included in the communication route, or (2) the link is included in the communication route.

The above route calculation will be described by giving a specific example. A wireless communication system 200 includes terminal stations 2a and 2b. The terminal stations 2a and 2b form a communication area corresponding to one cell. The communication area is referred to as a cell 22a. Initially, the cell 22a is covered by an RU 42a that is associated with a terrestrial base station 4a.

Here, a description will be made on a case of changing a communication route when it becomes impossible to use the communication route 50 constituted by a service link 8a and a feeder link 12a because the feeder link 12a becomes unavailable for communication. That is, since it is required to change the RU to cover the cell 22a, the required number of RUs is one.

First, a terrestrial base station 4b associated with the node station 6b will be considered. In the terrestrial base station 4b, an RU 42c covers a cell 22b formed by a terminal station 2c. Furthermore, in the terrestrial base station 4b, an RU 42d covers a cell 22c formed by a terminal station 2d. That is, the number of unused RUs is zero. The number is below one, which is the required number of RUs. Therefore, the network controller 40 excludes a feeder link 12b to the terrestrial base station 4b from cost value calculation targets.

Next, a terrestrial base station 4c associated with the node station 6c will be considered. In the terrestrial base station 4c, an RU 42e covers a cell 22d formed by a terminal station 2e. An RU 42f is, however, not used. That is, the number of unused RUs is one. The number is not below one, which is the required number of RUs. Therefore, the network controller 40 causes a feeder link 12c to the terrestrial base station 4c to be a cost value calculation target. As a result, it is only the feeder link 12c to the terrestrial base station 4c that is caused to be a cost value calculation target in the wireless communication system 200. Therefore, it is not necessary for the network controller 40 to calculate cost values to select a communication route. That is, by making a change so that the RU 42f, which is an unused RU of the terrestrial base station 4c, covers the cell 22a, a change is made so that a communication route 52 is used.

In an NTN, the altitude of a node station is high, and a long delay occurs in communication with a terminal station on the earth. For example, in the case of a GEO satellite, delay time is about 125 ms. In the present disclosure, not only band usage rates but also delay times are included in the cost to calculate a route. Thereby, a node station with a short delay time and a low altitude is preferentially selected, and, therefore, it is possible to perform optimization so that time required until completion of transmission of traffic is minimized. That is, even when the regenerative relaying method is not used, it is possible to perform NTN route control.

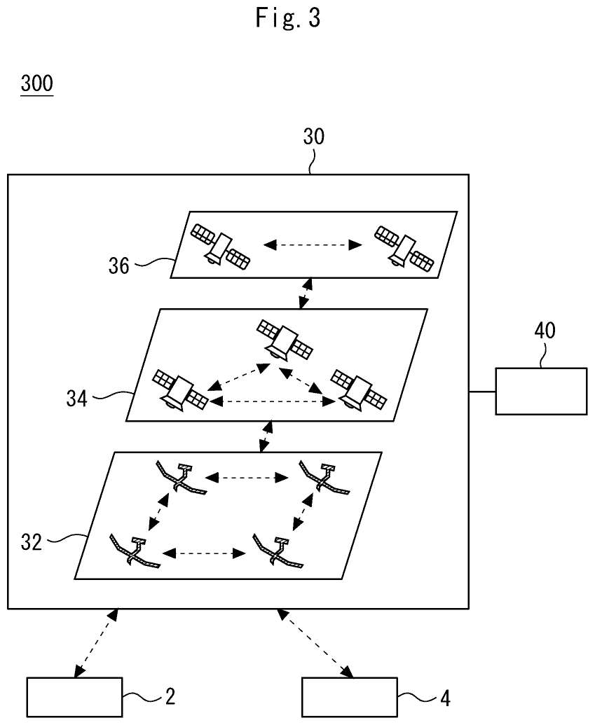

FIG. 3 is a diagram showing a configuration of a modification of the wireless communication system according to the first embodiment of the present disclosure. A wireless communication system 300 includes an NTN 30 that relays communication between the terminal station 2 and the terrestrial base station 4.

The NTN 30 includes, for example, a low earth orbit satellite network 32, a medium earth orbit satellite network 34, and a geostationary earth orbit satellite network 36. Each of the low earth orbit satellite network 32, the medium earth orbit satellite network 34, and the geostationary earth orbit satellite network 36 is a network constituted by node stations of the same type and the networks can mutually form communication links. The NTN 30 is formed by combining the plurality of networks. As the node stations, high-altitude pseudo satellites (HAPS), drones, unmanned aerial vehicles (UAV), aircrafts, and the like can be used in addition to the above. Note that the communication links may be wireless communication links or optical wireless communication links.

Thus, the wireless communication system 300 includes the plurality of node stations in the sky, and the communication links are connected among the node stations. Furthermore, a communication link to the terrestrial base station 4 is also formed, and a network is formed for each node station type.

Furthermore, the NTN 30 is connected to the network controller 40. In the case of a centralized control method, the network controller 40 performs necessary processes required to calculate a communication route. The necessary processes are, for example, management of band usage statuses of communication links, management of the number of unused RUs of the terrestrial base station, determination of a communication route, and allocation of bands to the communication links. Note that, in the case of a distributed control method, the network controller 40 is unnecessary because the above necessary processes are performed in each node station.

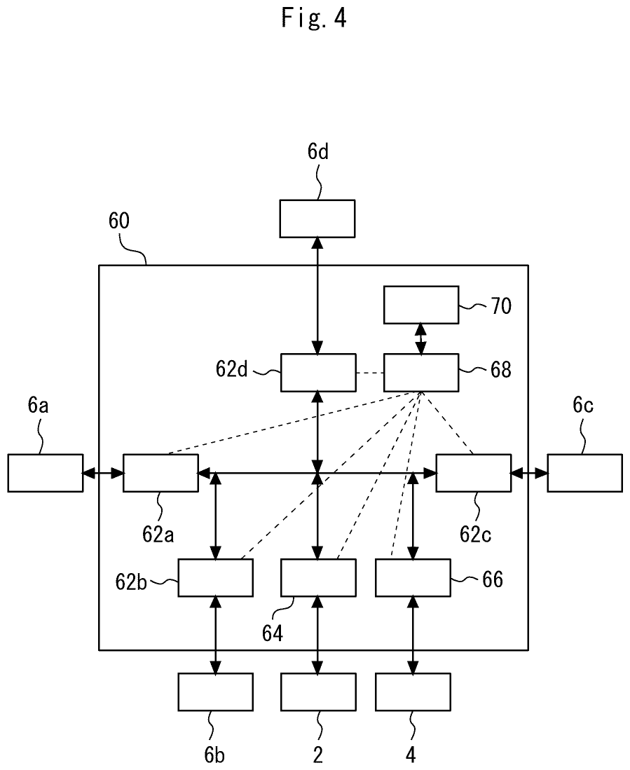

FIG. 4 is a diagram showing a configuration of a wireless communication device mounted on a node station, according to the first embodiment of the present disclosure. Here, a description will be made on an example of a case where NTN control is performed in the distributed control method.

A wireless communication device 60 includes an inter-node station communication device 62a. The inter-node station communication device 62a connects a communication link to the node station 6a close thereto and performs communication. Furthermore, the wireless communication device 60 includes inter-node station communication devices 62b to 62e. The inter-node station communication devices 62b to 62e connect communication links to node stations 6b to 6e close thereto and perform communication, similarly to the inter-node station communication device 62a.

The wireless communication device 60 includes an inter-terminal station communication device 64. The inter-terminal station communication device 64 connects a communication link to the terminal station 2 and performs communication. Furthermore, the wireless communication device 60 includes an inter-terrestrial base station communication device 66. The inter-terrestrial base station communication device 66 connects a communication link to the terrestrial base station 4 and performs communication.

The wireless communication device 60 includes a management device 68. The management device 68 aggregates pieces of information about communication links obtained from the inter-node station communication devices 62a to 62e, the inter-terminal station communication device 64, and the inter-terrestrial base station communication device 66 and notifies a route control device 70 of the information. The route control device 70 determines a communication route based on the notified information and notifies the management device 68 of the communication route. The management device 68 allocates required bands to communication links selected as a communication route. Then, the management device 68 transmits allocation information to corresponding devices, respectively.

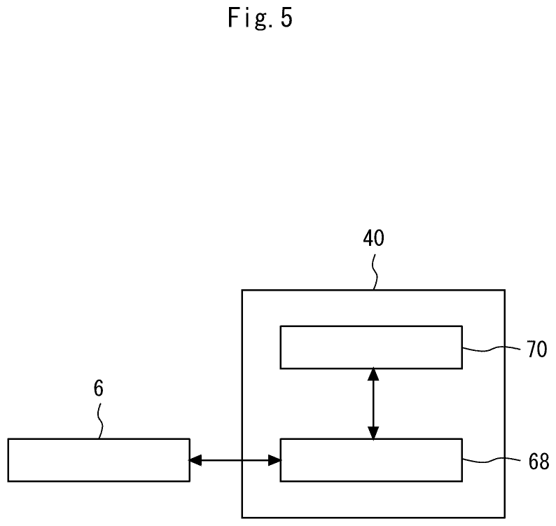

Note that, when the NTN control is performed in the centralized control method, the route control device 70 is unnecessary because the wireless communication device 60 does not determine a communication route. In this case, the network controller 40 to be described with reference to FIG. 5 is notified of the information of the management device 68. Then, based on a notification from the network controller 40, the management device 68 allocates required bands to communication links selected as a communication route. Then, the management device 68 transmits allocation information to corresponding devices, respectively.

FIG. 5 is a diagram showing a configuration of the network controller according to the first embodiment of the present disclosure. Here, a description will be made on an example of a case where NTN control is performed in the centralized control method.

The network controller 40 includes a management device 68. The management device 68 aggregates pieces of information about communication links notified from the node stations and notifies the route control device 70 of the information. The route control device 70 determines a communication route based on the notified information and notifies the management device 68 of the communication route. The management device 68 allocates required bands to communication links selected as a communication route. Then, the management device 68 transmits allocation information to corresponding devices, respectively.

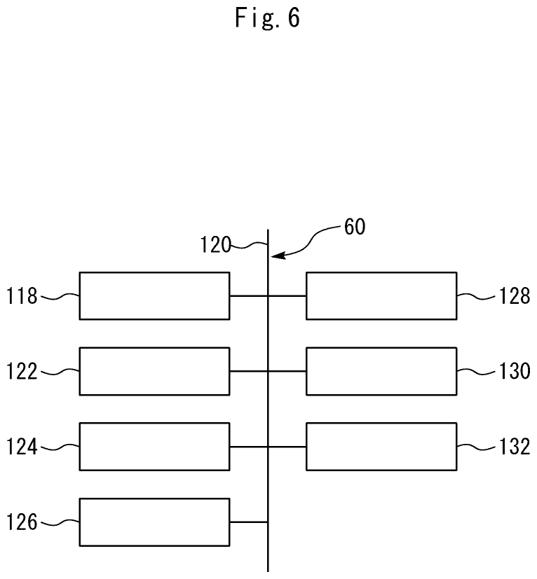

FIG. 6 is a diagram showing a hardware configuration of the wireless communication device according to the first embodiment of the present disclosure. The wireless communication device 60 includes a CPU 118. The CPU 118 is connected to a bus line 120. To the bus line 120, memory devices such as a ROM 122, a RAM 124, and a storage 126 are connected. In a memory device, a wireless communication program to be executed by the CPU 118 is stored. The wireless communication device 60 can realize functions unique to the present embodiment by the CPU 118 executing the wireless communication program.

A communication interface 128 is also connected to the bus line 120. The route control device 70 realizes communication with a network via the communication interface 128. An operation section 130 and a display section 132 are further connected to the bus line 120. The operation section 130 and the display section 132 function as user interfaces for handling the wireless communication device 60.

As described above, the wireless communication device 60 can realize the functions unique to the present embodiment by the CPU 118 executing the wireless communication program. That is, the wireless communication device 60 can be realized by a computer and the program. Furthermore, it is also possible to provide the program by recording the program to a recording medium or via a network. Note that, when the NTN control is performed in the centralized control method, the wireless communication device 60 in FIG. 6 can be replaced with the network controller 40.

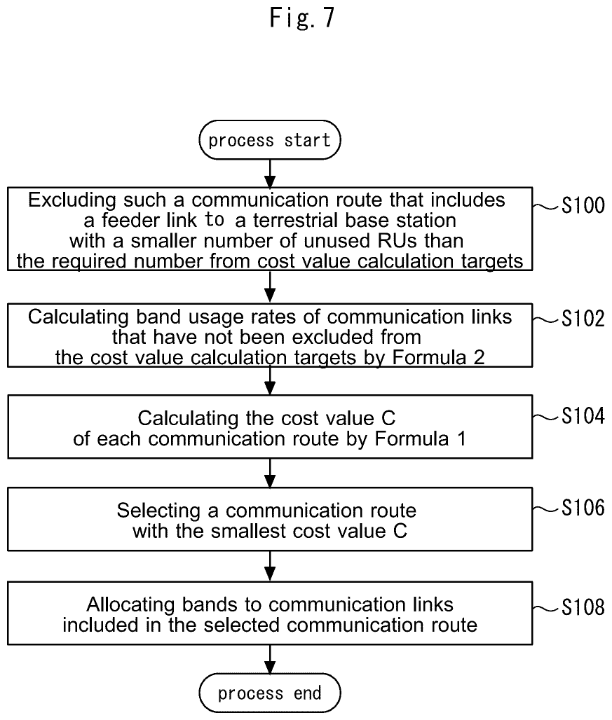

FIG. 7 is a flowchart showing a route calculation method according to the first embodiment of the present disclosure. First, at step 100, such a communication route that includes a feeder link to a terrestrial base station with a smaller number of unused RUs than the required number is excluded from cost value calculation targets. This step is performed by the route control device 70.

Note that, when a communication link the available band of which is below a required bandwidth is not to be included in a communication route, such a communication route that includes a communication link the available band of which is below the required bandwidth is also excluded from the cost value calculation targets, in addition to the communication link that includes the feeder link described above.

Next, at step 102, band usage rates of communication links that have not been excluded from the cost value calculation targets are calculated by Formula 2. This step is performed by the route control device 70.

Next, at step 104, the cost value C of each communication route is calculated by Formula 1. First, a plurality of communication routes to be candidates are set in advance. At this time, the communication routes excluded from the cost value calculation targets at step 100 are not included in the plurality of communication routes to be the candidates. Then, the cost value C is calculated for each of the set plurality of communication routes. This step is performed by the route control device 70.

Next, at step 106, a communication route with the smallest cost value C is selected. This step is performed by the route control device 70.

Next, at step 108, bands are allocated to communication links included in the selected communication route. This step is performed by the management device 68.

### Second Embodiment

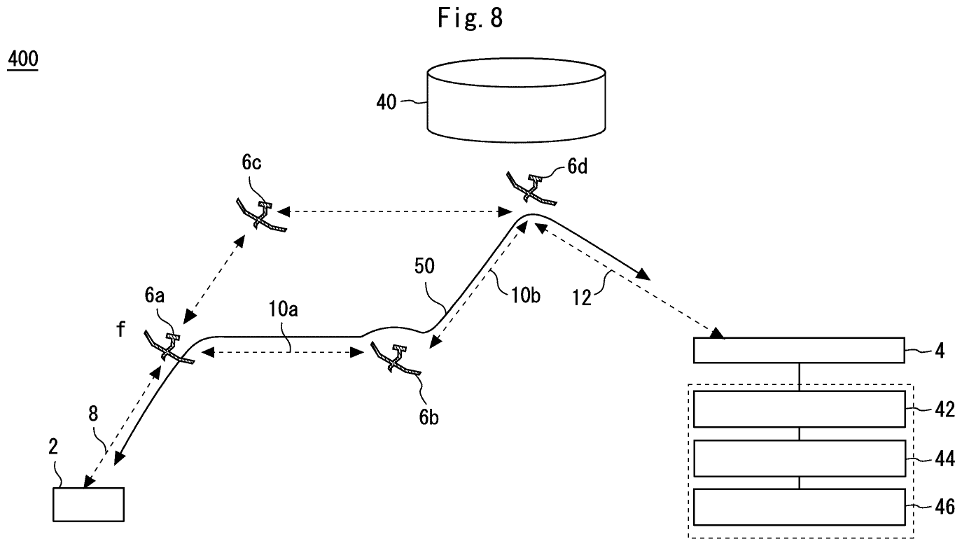

FIG. 8 is a diagram showing a wireless communication system according to a second embodiment of the present disclosure. The configuration of a wireless communication system 400 is similar to that of the first embodiment. The second embodiment is, however, different from the first embodiment in that the number of hops is considered at the time of calculating cost values.

In the non-regenerative relaying method, a signal is not demodulated when a node station relays the signal. Therefore, when the number of node stations that perform relay, that is, the number of hops increases, there may be a case where the carrier-to-noise ratio (CNR) and the signal-to-noise ratio (SNR) decrease, and a line capacity required for communication links cannot be secured.

Therefore, in the present embodiment, the number of hops is considered as a cost value of each communication route at the time of determining a communication route. That is, when there are a plurality of communication route candidates, the cost value C of each communication route is calculated by Formula 4, and a communication route with the smallest cost value C is selected.

$$C = {\sum }_{i = 1}^{n} {C}_{i} + \frac{n}{reference value of the number of hops} \qquad [ Formula 4 ]$$

Note that the reference value of the number of hops is any value. Furthermore, the cost value Ci of the communication link i is calculated by a method similar to that of the first embodiment. By preferentially selecting a communication route with a smaller number of hops, it is possible to prevent decrease in the CNR and the SNR.

A specific example of calculation of the cost value C will be shown. Here, an example of calculating the cost value C of the communication route 50 in the wireless communication system 400 will be shown. The communication route 50 is a communication route where the node stations 6a, 6b, and 6d perform relay, but the node station 6c does not perform relay.

The communication route 50 passes through the communication links 10a and 10b, and the feeder link 12. The cost values Ci of the communication links are 1, 0.5, and 1.5, respectively. The number of hops is three. When the reference value of the number of hops is three, the cost value C is calculated as shown by Formula 5.

$$C = ( {C}_{1} + {C}_{2} + {C}_{3} ) + \frac{n}{reference value of the number of hops} = ( 1 + 0.5 + 1.5 ) + \frac{3}{3} = 4 \qquad [ Formula 5 ]$$

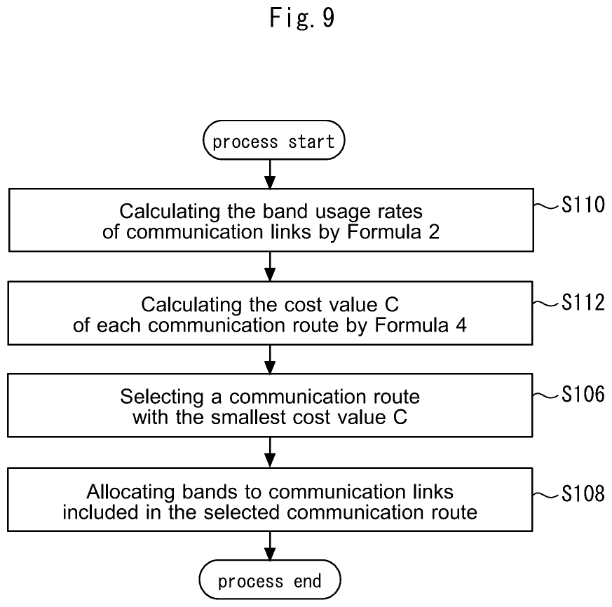

FIG. 9 is a flowchart showing a route calculation method according to the second embodiment of the present disclosure. A processing method of the present embodiment will be described using the flowchart of FIG. 9. Note that, as for each step in the flowchart, description may be appropriately omitted when the content is duplicated.

First, at step 110, the band usage rates of communication links are calculated by Formula 2. This step is performed by the route control device 70. Next, at step 112, the cost value C of each communication route is calculated by Formula 4. First, a plurality of communication routes to be candidates are set in advance. Then, the cost value C is calculated for each of the set plurality of communication routes. This step is performed by the route control device 70.

Next, at step 106, a communication route with the smallest cost value C is selected. This step is performed by the route control device 70.

Next, at step 108, bands are allocated to communication links included in the selected communication route. This step is performed by the management device 68.

### Third Embodiment

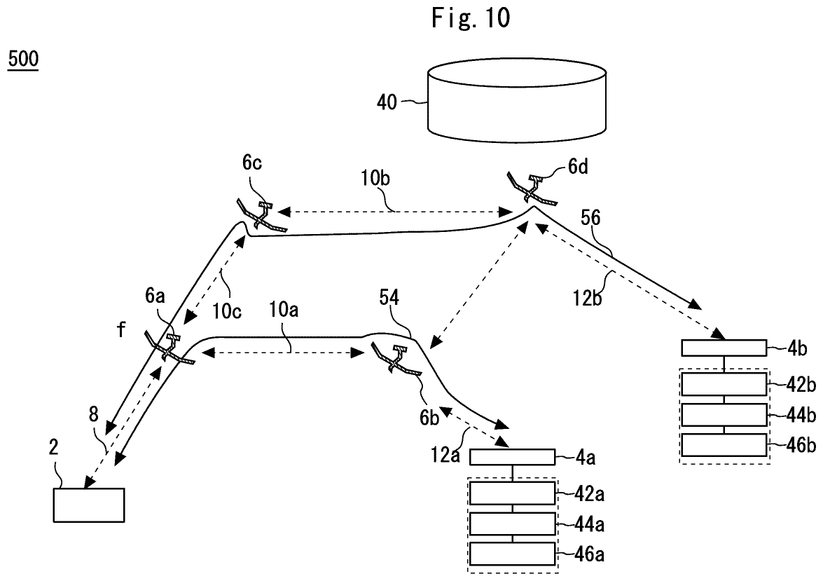

FIG. 10 is a diagram showing a wireless communication system according to a third embodiment of the present disclosure. The third embodiment is different from the first embodiment in that, at the time of calculating cost values, such a communication route that total delay time exceeds a threshold is excluded.

In an NTN configuration in which RUs are arranged in terrestrial base stations, there may be a case where, due to distances among node stations, that is, propagation delay of communication links and the number of hops, delay time required for communication between a terminal station and the RU increases, and communication becomes unavailable.

Therefore, in the present embodiment, a threshold is set for total delay time of a communication route. For each communication route for which the cost value C has been calculated, the total delay time is also calculated. Here, the total delay time is a total value of delay times of communication links and node stations included in each communication route. Then, such a communication route that the total delay time exceeds the threshold is excluded from choices. Then, a communication route with the smallest cost value C is selected from among communication routes that have not been excluded. Note that the delay time of each of the communication links and node stations may be an actually measured value or a fixed value.

Thus, by excluding such a communication route that the total delay time exceeds the threshold as above, it is possible to prevent communication from being unavailable.

A specific example of calculation of the cost value C will be shown. Here, an example of calculating the cost values C of communication routes 54 and 56 in a wireless communication system 500 will be shown.

The communication route 54 passes through the service link 8, the node station 6a, the communication link 10a, the node station 6b, and the feeder link 12a. Propagation delays of the communication links and the nodes are 2 ms, 1 ms, 1 ms, 1 ms, and 2 ms, respectively. That is, the total delay time of the communication route 54 is 7 ms.

The communication route 56 passes through the service link 8, the node station 6a, the communication link 10c, the node station 6c, the communication link 10b, the node station 6d, and the feeder link 12b. Propagation delays of the communication links and the nodes are 2 ms, 1 ms, 1 ms, 1 ms, 1 ms, 1 ms, and 2 ms, respectively. That is, the total delay time of the communication route 56 is 9 ms.

Here, it is assumed that the threshold for the total delay time is 8 ms. The communication route 54 is not excluded from the choices because the total delay time does not exceed the threshold. The communication route 56 is excluded from the choices because the total delay time exceeds the threshold.

In the present embodiment, a communication route with the smallest cost C is selected from among communication routes that have not been excluded from the choices. Therefore, if a choice with a cost value C smaller than that of the communication route 54 does not exist, the communication route 54 is selected.

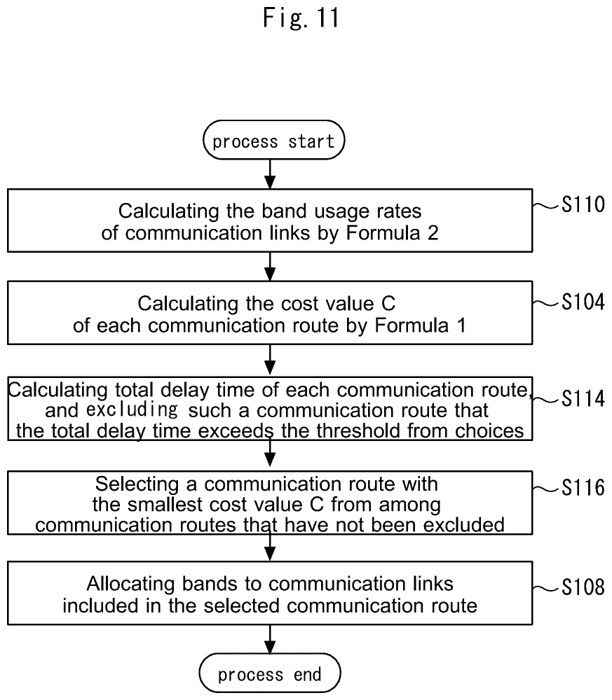

FIG. 11 is a flowchart showing a route calculation method according to the third embodiment of the present disclosure. A processing method of the present embodiment will be described using the flowchart of FIG. 11. Note that, as for each step in the flowchart, description may be appropriately omitted when the content is duplicated.

First, at step 110, the band usage rates of communication links are calculated by Formula 2. This step is performed by the route control device 70. Next, at step 104, the cost value C of each communication route is calculated by Formula 1. First, a plurality of communication routes to be candidates are set in advance. Then, the cost value C is calculated for each of the set plurality of communication routes. This step is performed by the route control device 70. Note that the cost value C of each communication route may be calculated by Formula 4 like step 112.

Next, at step 114, total delay time of each communication route is calculated, and such a communication route that the total delay time exceeds the threshold is excluded from choices. That is, the excluded communication route is not included in the plurality of communication routes to be candidates. This step is performed by the route control device 70.

Next, at step 116, a communication route with the smallest cost value C is selected from among communication routes that have not been excluded. This step is performed by the route control device 70.

Next, at step 108, bands are allocated to communication links included in the selected communication route. This step is performed by the management device 68.

### Fourth Embodiment

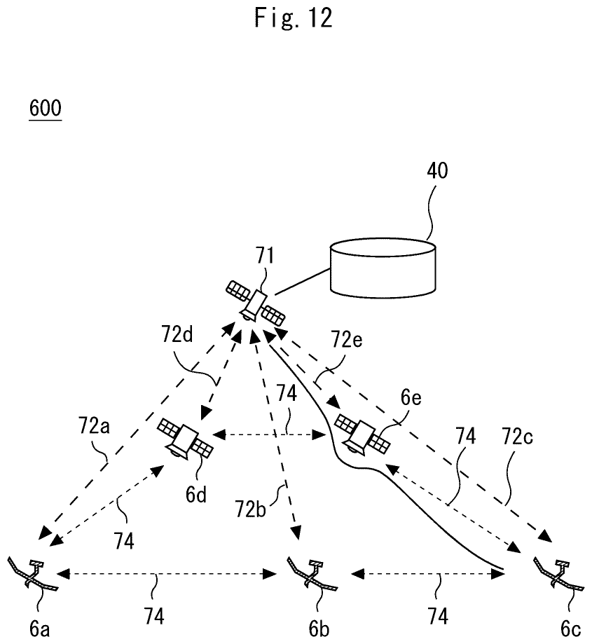

FIG. 12 is a diagram showing a wireless communication system according to a fourth embodiment of the present disclosure. The fourth embodiment is different from the first embodiment in that the network controller is arranged in a GEO satellite.

A wireless communication system 600 includes a GEO satellite 71.

The GEO satellite 71 includes the network controller 40. The network controller 40 implements a protocol for collecting basic data required to calculate the cost values C.

Furthermore, the GEO satellite 71 is connected to the node stations 6a to 6e via communication links 72a to 72e, respectively. The communication area of the GEO satellite 71 is wide and can directly communicate with all the node stations constituting the NTN. The present embodiment utilizes this characteristic.

The node stations 6a to 6e notify the GEO satellite 71 of pieces of information required to calculate the cost values C via the communication links 72a to 72e, respectively. The GEO satellite 71 calculates the cost values C based on the notified pieces of information and determines a communication route. Then, the GEO satellite 71 notifies the node stations 6a to 6e of information about the determined communication route.

Note that the GEO satellite 71 may exchange information by directly communicating with each node station or may exchange information via a plurality of node stations.

Recently, it has been required to strengthen the national land against natural disasters and the like, and appearance of a communication system resistant to ground disasters has been desired. In the present embodiment, it is possible to, by arranging the network controller in the GEO satellite, perform NTN route control without being affected by ground disasters.

### REFERENCE SIGNS LIST

2, 2a, 2b terminal station
4, 4a, 4b, 4c terrestrial base station
6a, 6b, 6c, 6d, 6e node station
10a, 10b, 10c communication link
12, 12a, 12b, 12c feeder link
14 band
19a, 19b, 19c band
20a, 20b, 20c band
40 network controller
50, 52, 54, 56 communication route
60 wireless communication device
68 management device
70 route control device
72a, 72b, 72c, 72d, 72e communication link
100, 200, 300, 400, 500, 600 wireless communication system

1. A wireless communication system for performing communication using a non-terrestrial network constructed by a non-regenerative relaying method, the wireless communication system comprising:
a terminal station, a terrestrial base station, a plurality of node stations constituting the non-terrestrial network, a route control circuitry, and a management circuitry, wherein
the route control circuitry is configured to perform:
calculating band usage rates of communication links formed among the plurality of node stations;
setting a plurality of communication routes to be candidates;
calculating cost values of the plurality of communication routes to be the candidates, based on the band usage rates and delay times; and
comparing the cost values and selecting a communication route with the smallest cost value from among the plurality of communication routes to be the candidates, and
the management circuitry is configured to perform allocating bands to communication links included in the selected communication route, and
the terminal station and the terrestrial base station perform wireless communication using the bands allocated to the communication links included in the selected communication route.

2. The wireless communication system according to claim 1, wherein
the terrestrial base station comprises radio units, each of the radio units forming one communication area, and transmits the number of unused radio units comprised in the terrestrial base station to the management circuitry,
the management circuitry transmits the number of unused radio units to the route control circuitry,
the route control circuitry is configured to further perform a first excluding, when the number of unused radio units is smaller than the required number of radio units, a communication route including a feeder link to the corresponding terrestrial base station from cost value calculation targets, and
the plurality of communication routes to be the candidates do not include the communication route excluded by the first excluding.

3. The wireless communication system according to claim 1, wherein
the calculating cost values is performed based on the number of hops of the communication routes concerned in addition to the band usage rates and the delay times.

4. The wireless communication system according to claim 1, wherein
the route control circuitry is configured to further perform:
calculating total delay time of each of the communication routes to be the candidates; and
a second excluding such a communication route that the total delay time exceeds a threshold, from the communication routes to be the candidates, and
the plurality of communication routes to be the candidates do not include the communication route excluded by the second excluding.

5. The wireless communication system according to claim 1, further comprising a network controller arranged in a GEO satellite, wherein
the network controller comprises the route control circuitry.

6. A wireless communication method implemented by a wireless communication system, the wireless communication system performing communication using a non-terrestrial network constructed by a non-regenerative relaying method and configured with a plurality of node stations, and the wireless communication method comprising:
calculating band usage rates of communication links formed among the plurality of node stations;
setting a plurality of communication routes to be candidates;
calculating cost values of the plurality of communication routes to be the candidates, based on the band usage rates and delay times;
comparing the cost values and selecting a communication route with the smallest cost value from among the plurality of communication routes to be the candidates;
allocating bands to communication links included in the selected communication route; and
performing wireless communication using the bands allocated to the communication links included in the selected communication route.

7. A wireless communication device comprised in a wireless communication system, the wireless communication system performing communication using a non-terrestrial network constructed by a non-regenerative relaying method and configured with a plurality of node stations, and the wireless communication device comprising a route control circuitry and a management circuitry, wherein
the route control circuitry is configured to perform:
calculating band usage rates of communication links formed among the plurality of node stations;
setting a plurality of communication routes to be candidates;
calculating cost values of the plurality of communication routes to be the candidates, based on the band usage rates and delay times; and
comparing the cost values and selecting a communication route with the smallest cost value from among the plurality of communication routes to be the candidates, and
the management circuitry is configured to perform for allocating bands to communication links included in the selected communication route.

8. A storage medium storing a computer readable wireless communication program configured to cause a computer to execute the wireless communication method according to claim 6.
